(19) United States
(12) Patent Application Publication
(10) Pub. No.: US 2026/0342229 A1
(43) Pub. Date: Oct. 29, 2026

(54) CONTROL CIRCUIT FOR HYBRID SWITCHED-MODE POWER CONVERTER

(71) Applicant: Richtek Technology Corporation, Zhubei City (TW)

(72) Inventors: Ta-Yung Yang, Taoyuan (TW); Kuo-Chi Liu, Hsinchu (TW); Kwan-Jen Chu, Hsinchu (TW)

(21) Appl. No.: 19/386,072

(22) Filed: Nov. 11, 2025

Related U.S. Application Data
(60) Provisional application No. 63/776,953, filed on Mar. 24, 2025.

(30) Foreign Application Priority Data
Aug. 15, 2025 (TW) 114131197

(51) Int. Cl. H02M 3/158; H02M 1/00; H02M 1/14; H02M 3/07

(52) U.S. Cl. CPC H02M 3/158; H02M 1/0095; H02M 1/14; H02M 3/07

(57) ABSTRACT

A control circuit is configured to control a hybrid switched-mode power converter which includes a plurality of transistors, a flying capacitor, and an inductor circuit. The control circuit includes: a charge signal for controlling a first transistor among the plurality of transistors to generate a charge current, such that a first power voltage charges the flying capacitor through the first transistor; and a discharge signal for controlling a second transistor among the plurality of transistors to generate a discharge current, such that the flying capacitor is discharged through the second transistor. The charge and discharge signals are non-overlapping. The control circuit is configured to adjust a pulse width of the charge signal and/or a pulse width of the discharge signal according to a voltage across the flying capacitor, so as to regulate the voltage across the flying capacitor within an error range.

### CROSS REFERENCE

The present invention claims priority to provisional application 63/776,953 filed on Mar. 24, 2025, and TW 114131197 filed on Aug. 15, 2025.

### BACKGROUND OF THE INVENTION

### Field of Invention

The present invention relates to a control circuit, and more particularly to a control circuit configured to control a hybrid switched-mode power converter.

### Description of Related Art

With recent technological advancements, graphics processing units (GPUs) and artificial intelligence application-specific integrated circuits (AI ASICs) are requiring lower supply voltages (typically ranging from 0.6V to 1V), and are adopting vertical power delivery (VPD) to improve power efficiency. This trend has driven a strong market demand for power converters that offer high efficiency, high power density, and fast transient response while using compact inductors. At the same time, high-voltage power rails (e.g., 48V) are increasingly used to reduce conduction losses during power transmission. Therefore, power converters with high voltage conversion ratios have become essential technologies. A series capacitor buck converter (SCBC) meets these demands by providing a high conversion ratio (e.g., 4:1 or 8:1) and supporting high output current. However, to maximize efficiency and minimize output current ripple, the flying capacitor voltage in an SCBC must be balanced, for example, at Vin/2.

### SUMMARY OF THE INVENTION

From one perspective, the present invention provides a control circuit configured to control a hybrid switched-mode power converter, wherein the hybrid switched-mode power converter includes a plurality of transistors, a flying capacitor, and an inductor circuit, the inductor circuit including at least one inductor; wherein the plurality of transistors are configured to be periodically switched under control of the control circuit, so as to switch electrical connections between the flying capacitor and a first power voltage, the inductor circuit, and a ground potential, and between the inductor circuit and the flying capacitor, the ground potential, and a second power voltage, thereby performing power conversion between the first power voltage and the second power voltage in a pulse width modulation (PWM) manner; wherein the control circuit comprises: a charge signal, configured to control a first transistor among the plurality of transistors to generate a charge current, such that the first power voltage charges the flying capacitor through the first transistor; and a discharge signal, configured to control a second transistor among the plurality of transistors to generate a discharge current, such that the flying capacitor is discharged through the second transistor; wherein the charge signal and the discharge signal are non-overlapping; wherein the control circuit is configured to perform, according to a voltage across the flying capacitor, a first adjustment operation to adjust a pulse width of the charge signal, and/or a second adjustment operation to adjust a pulse width of the discharge signal, so as to regulate the voltage across the flying capacitor within an error range with respect to a target voltage, the error range being associated with a first predetermined threshold and a second predetermined threshold; wherein the first predetermined threshold is greater than the target voltage, and the second predetermined threshold is less than the target voltage, wherein the target voltage is positively correlated with a divided voltage of the first power voltage.

In one embodiment, the first adjustment operation includes: decreasing the pulse width of the charge signal when the voltage across the flying capacitor is higher than the first predetermined threshold; and increasing the pulse width of the charge signal when the voltage across the flying capacitor is lower than the second predetermined threshold; wherein the second adjustment operation includes: increasing the pulse width of the discharge signal when the voltage across the flying capacitor is higher than the first predetermined threshold; decreasing the pulse width of the discharge signal when the voltage across the flying capacitor is lower than the second predetermined threshold.

In one embodiment, the control circuit further comprises: a first input signal; a second input signal; and a correction signal; wherein the first adjustment operation further includes: generating the correction signal based on a pulse width of the first input signal; generating the charge signal based on the first input signal and the correction signal; wherein when the voltage across the flying capacitor is higher than the first predetermined threshold, a pulse width of the correction signal is decreased so that the pulse width of the charge signal is decreased, and when the voltage across the flying capacitor is lower than the second predetermined threshold, the pulse width of the correction signal is increased so that the pulse width of the charge signal is increased; wherein the second adjustment operation further includes: generating the correction signal based on a pulse width of the second input signal; and generating the discharge signal based on the second input signal and the correction signal; wherein when the voltage across the flying capacitor is higher than the first predetermined threshold, the pulse width of the correction signal is increased so that the pulse width of the discharge signal is increased, and when the voltage across the flying capacitor is lower than the second predetermined threshold, the pulse width of the correction signal is decreased so that the pulse width of the discharge signal is decreased.

In one embodiment, the plurality of transistors of the hybrid switched-mode power converter further include a third transistor and a fourth transistor, configured to be periodically switched based on a first control signal and a second control signal, respectively; wherein the control circuit further includes a first non-overlapping circuit, configured to generate the charge signal and the first control signal based on the first input signal, or based on the first input signal and the correction signal; wherein when the third transistor and the second transistor are not turned on, the first transistor is turned on.

In one embodiment, the plurality of transistors of the hybrid switched-mode power converter further include a third transistor and a fourth transistor, configured to be periodically switched based on a first control signal and a second control signal, respectively; wherein the control circuit further includes a second non-overlapping circuit, configured to generate the discharge signal and the second control signal based on the second input signal, or based on the second input signal and the correction signal; wherein when the fourth transistor and the first transistor are not turned on, the second transistor is turned on.

In one embodiment, the control circuit further comprises: an amplification circuit, configured to generate a capacitor voltage signal according to a first terminal voltage and a second terminal voltage of the flying capacitor; a comparison circuit, configured to compare the capacitor voltage signal with a first threshold reference voltage, or to compare the capacitor voltage signal with a second threshold reference voltage, so as to generate an over-voltage signal when the capacitor voltage signal is higher than the first threshold reference voltage, indicating that the voltage across the flying capacitor is higher than the first predetermined threshold; and to generate an under-voltage signal when the capacitor voltage signal is lower than the second threshold reference voltage, indicating that the voltage across the flying capacitor is lower than the second predetermined threshold; wherein the first threshold reference voltage and the second threshold reference voltage are positively correlated with the first predetermined threshold and the second predetermined threshold, respectively.

In one embodiment, the control circuit further comprises: a timing circuit; wherein the first adjustment operation further includes: the timing circuit being configured to generate a time voltage based on the pulse width of the first input signal; wherein the second adjustment operation further includes: the timing circuit being configured to generate the time voltage based on the pulse width of the second input signal.

In one embodiment, the control circuit further comprises: a correction voltage, generated based on a sum of the time voltage and a bias voltage; wherein the bias voltage is generated based on a bias resistor and an adjustment current; wherein the second adjustment operation further includes: adjusting the adjustment current to adjust the correction voltage when the over-voltage signal is enabled, so as to decrease the pulse width of the charge signal, and adjusting the adjustment current to adjust the correction voltage when the under-voltage signal is enabled, so as to increase the pulse width of the charge signal; wherein the second adjustment operation further includes: adjusting the adjustment current to adjust the correction voltage when the over-voltage signal is enabled, so as to increase the pulse width of the discharge signal, and adjusting the adjustment current to adjust the correction voltage when the under-voltage signal is enabled, so as to decrease the pulse width of the discharge signal.

In one embodiment, the first adjustment operation further includes: adjusting the pulse width of the correction signal according to the correction voltage; and adjusting the charge signal according to the correction signal; wherein the second adjustment operation further includes: adjusting the pulse width of the correction signal according to the correction voltage; and adjusting the discharge signal according to the correction signal.

In one embodiment, the first adjustment operation further includes: adjusting the charge signal in a cycle-by-cycle manner to gradually regulate the voltage across the flying capacitor; wherein the second adjustment operation further includes: adjusting the discharge signal in the cycle-by-cycle manner to gradually regulate the voltage across the flying capacitor; wherein the cycle-by-cycle manner corresponds to each switching cycle of the first input signal or each switching cycle of the second input signal.

In one embodiment, in the first adjustment operation, an enable time point of the correction signal is synchronized with an enable time point of the first input signal; wherein, in the second adjustment operation, the enable time point of the correction signal is synchronized with an enable time point of the second input signal.

In one embodiment, the control circuit further comprises a counter and an adjustment current generator; wherein the first adjustment operation further includes: the counter being configured to count to generate a first count value based on the first input signal, the over-voltage signal, and the under-voltage signal; and the adjustment current generator being configured to generate the adjustment current according to the first count value; wherein the counter is configured to start operating based on an enable time point of the first input signal; wherein when the over-voltage signal is enabled, the counter decrements the first count value so that the adjustment current is reduced to lower the correction voltage, and when the under-voltage signal is enabled, the counter increments the first count value so that the adjustment current is increased to raise the correction voltage; wherein the second adjustment operation further includes: the counter being configured to generate a second count value based on the second input signal, the over-voltage signal, and the under-voltage signal; and the adjustment current generator being configured to generate the adjustment current according to the second count value; wherein the counter is configured to start operating based on an enable time point of the second input signal; wherein when the over-voltage signal is enabled, the counter increments the second count value so that the adjustment current is increased to raise the correction voltage, and when the under-voltage signal is enabled, the counter decrements the second count value so that the adjustment current is reduced to lower the correction voltage.

In one embodiment, the first adjustment operation further includes: the pulse width of the charge signal being determined by a shorter one between the pulse width of the first input signal and the pulse width of the correction signal when the over-voltage signal is enabled; wherein the second adjustment operation further includes: the pulse width of the discharge signal being determined by a longer one between the pulse width of the second input signal and the pulse width of the correction signal when the over-voltage signal is enabled.

In one embodiment, the first adjustment operation further includes: the pulse width of the charge signal being determined by a longer one between the pulse width of the first input signal and the pulse width of the correction signal when the under-voltage signal is enabled; wherein the second adjustment operation further includes: the pulse width of the discharge signal being determined by a shorter one between the pulse width of the second input signal and the pulse width of the correction signal when the under-voltage signal is enabled.

In one embodiment, in the first adjustment operation, when the second input signal is enabled, the charge signal is disabled; wherein, in the second adjustment operation, when the first input signal is enabled, the discharge signal is disabled.

In one embodiment, the control circuit further comprises a pre-charging circuit configured to pre-charge the flying capacitor during a power-on period of the hybrid switched-mode power converter.

In one embodiment, the first input signal and the second input signal are non-overlapping signals; wherein the first input signal and the second input signal have a constant on-time.

In one embodiment, the control circuit is further configured to control a multi-phase power conversion circuit, wherein the multi-phase power conversion circuit includes a plurality of the hybrid switched-mode power converters and a multi-phase modulation circuit, wherein the multi-phase modulation circuit is configured to generate a corresponding plurality of pulse width modulation signals, respectively corresponding to the first input signal and the second input signal of each of the plurality of the hybrid switched-mode power converters.

The present invention discloses a control circuit for a hybrid switched-mode power converter. The control circuit measures a voltage across a flying capacitor and generates a correction signal through time-to-voltage conversion and counting conversion. Based on the correction signal, the pulse width of a charge signal and/or a discharge signal is adjusted on a cycle-by-cycle basis, so as to maintain the voltage across the flying capacitor between a first predetermined threshold and a second predetermined threshold, thereby reducing output ripple and improving efficiency.

The objectives, technical details, features, and effects of the present invention will be better understood with regard to the detailed description of the embodiments below, with reference to the attached drawings.

### BRIEF DESCRIPTION OF THE DRAWINGS

FIGS. 1A and 1B illustrate schematic diagrams of a hybrid switched-mode power converter in one embodiment of the present invention.

FIGS. 1C and 1D illustrate schematic diagrams of a hybrid switched-mode power converter in two other embodiments of the present invention.

FIG. 2 illustrates a schematic diagram showing a regulated range of a voltage across a flying capacitor in one embodiment of the present invention.

FIGS. 3A and 3B illustrate block diagrams of a portion of the control circuit of a hybrid switched-mode power converter in two embodiments of the present invention.

FIGS. 4A to 4C illustrate block diagrams of a portion of the control circuit of a hybrid switched-mode power converter in multiple embodiments of the present invention.

FIG. 5 illustrates a schematic diagram of a portion of the control circuit of a hybrid switched-mode power converter in one specific embodiment of the present invention.

FIG. 6 illustrates a schematic diagram of a portion of the control circuit of a hybrid switched-mode power converter in one specific embodiment of the present invention.

FIG. 7 illustrates a schematic diagram of a time-to-voltage conversion circuit of the control circuit in one specific embodiment of the present invention.

FIG. 8 illustrates a schematic diagram of a voltage-to-time conversion circuit of the control circuit in one specific embodiment of the present invention.

FIGS. 9A and 9B illustrate operational waveform diagrams corresponding to the operations shown in FIGS. 7 and 8 in two embodiments of the present invention.

FIG. 10 illustrates a schematic diagram of a counting conversion circuit of the control circuit in one specific embodiment of the present invention.

FIG. 11 illustrates a schematic diagram of a pre-charging circuit of the control circuit in one specific embodiment of the present invention.

FIG. 12 illustrates a schematic diagram of the control circuit controlling a multi-phase power conversion circuit in one embodiment of the present invention.

FIG. 13 illustrates an operational waveform diagram showing the operation of the multi-phase power conversion circuit corresponding to FIG. 12 in one embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

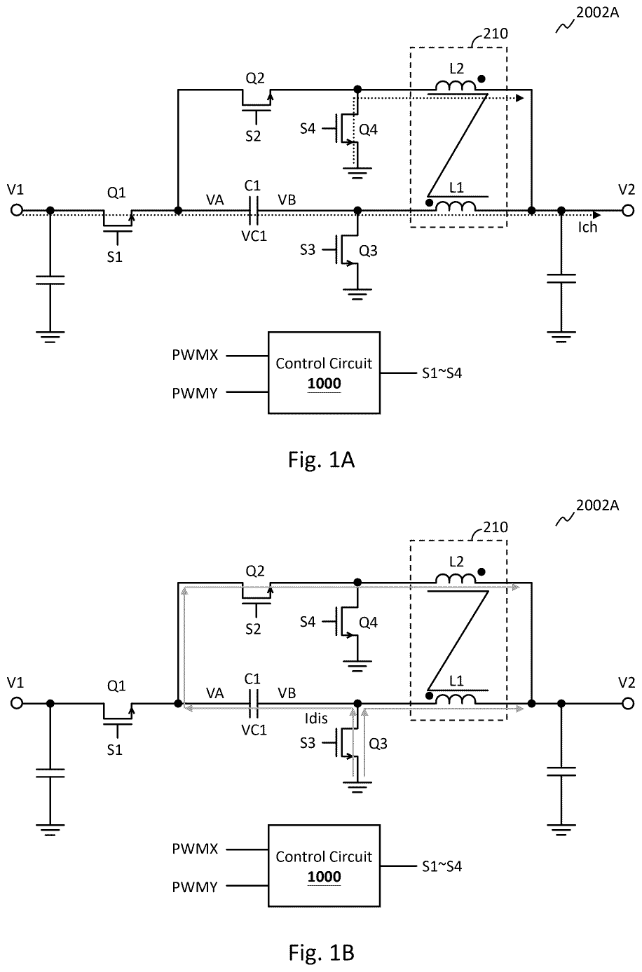

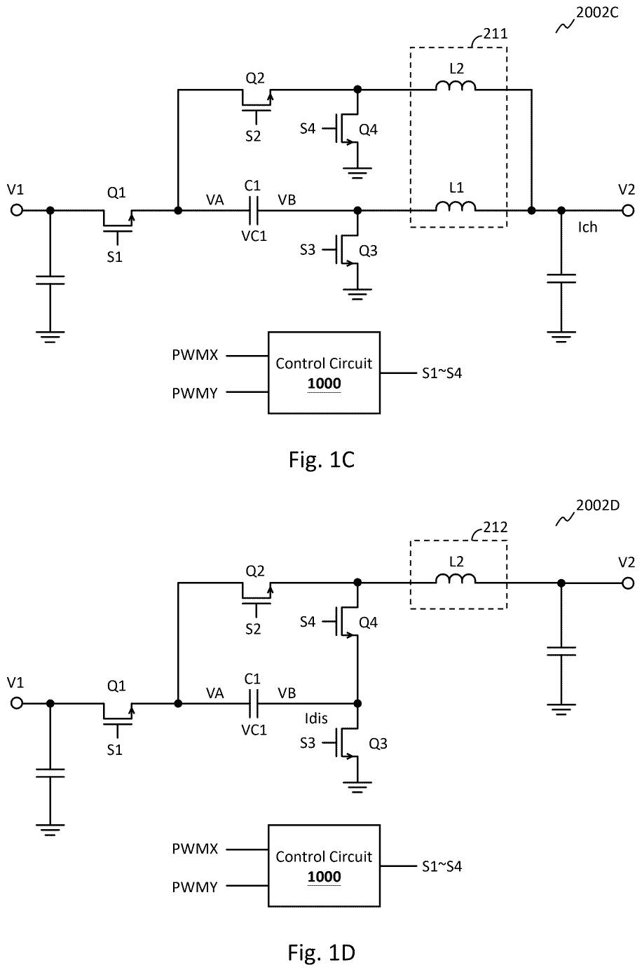

FIGS. 1A and 1B illustrate schematic diagrams of a hybrid switched-mode power converter in one embodiment of the present invention. The circuit structures of FIGS. 1A and 1B are identical, wherein FIG. 1A and FIG. 1B respectively illustrate the charging and discharging current paths of the flying capacitor C1. In one embodiment, the hybrid switched-mode power converter of the present invention includes a plurality of transistors, a flying capacitor, and an inductor circuit. In one specific embodiment, as shown in FIG. 1A, hybrid switched-mode power converter 2002A includes first to fourth transistors Q1 to Q4 (i.e., the plurality of transistors), the flying capacitor C1, and the inductor circuit 220. In this embodiment, the inductor circuit 220 includes inductors L1 and L2, and inductors L1 and L2 are magnetically coupled to each other. In one embodiment, the first to fourth transistors Q1 to Q4 are periodically switched under the control of control circuit 1000 to switch electrical connections between the flying capacitor C1 and a first power voltage V1, inductor circuit 210, and a ground potential, and to switch electrical connections between inductor circuit 210 and the flying capacitor C1, the ground potential, and a second power voltage V2. Accordingly, power conversion between the first power voltage V1 and the second power voltage V2 is performed through a two-level or higher pulse width modulation scheme. For example, a switching terminal of inductor circuit 210 (e.g., a left terminal of the inductor as shown in the figure) may switch between two voltage levels, such as V1×½ and 0 (i.e., the ground potential), in a three-level pulse width modulation scheme.

In one embodiment, the control circuit 1000 is configured to generate a charge signal S1, a discharge signal S2, a first control signal S3, and a second control signal S4 according to a first input signal PWMX and a second input signal PWMY.

In one embodiment, the first input signal PWMX and the second input signal PWMY are non-overlapping.

As shown in FIG. 1A, the charge signal S1 is configured to control the first transistor Q1 to turn on so as to generate a charge current Ich (as indicated by a short dashed line in FIG. 1A).

In this embodiment, the charge current Ich flows from the first power voltage V1 through the first transistor Q1 and inductor L1 to the second power voltage V2, such that the first power voltage V1 charges the flying capacitor C1 through the first transistor Q1.

Since a steady-state voltage VC1 across the flying capacitor C1 is V1×½, under this state, a voltage VB at a switching terminal of inductor L1 is V1 ×½, thus the inductor L1 is magnetized, while a voltage at a switching terminal of the inductor L2 is 0 (via conduction of Q4), and thus the inductor L2 is demagnetized.

On the other hand, in one embodiment, as shown in FIG. 1B, the discharge signal S2 is configured to control the second transistor Q2 to turn on so as to generate a discharge current Idis (as indicated by a solid gray line in FIG. 1B).

In this embodiment, the discharge current Idis flows from the ground potential through the third transistor Q3, the second transistor Q2, and the inductor L2 to the second power voltage V2, such that the flying capacitor C1 is discharged through the second transistor Q2.

It is noted that the charge signal S1 and the discharge signal S2 are non-overlapping.

In one embodiment, as shown in FIGS. 1A and 1B, the third transistor Q3 and the fourth transistor Q4 are periodically switched according to the first control signal S3 and the second control signal S4, respectively.

Specifically, when the first transistor Q1 is turned on, the second control signal S4 simultaneously turns on fourth transistor Q4, while the second transistor Q2 and the third transistor Q3 are turned off.

When the second transistor Q2 is turned on, the first control signal S3 simultaneously turns on the third transistor Q3, while the first transistor Q1 and the fourth transistor Q4 are turned off.

Under this state, a voltage at a switching terminal of inductor L1 is 0 (via conduction of Q3), and thus inductor L1 is demagnetized, while a voltage at a switching terminal of the inductor L2 is V1×½ (supplied by the flying capacitor C1), and thus the inductor L2 is magnetized.

FIGS. 1C and 1D illustrate schematic diagrams of hybrid switching power conversion circuits in accordance with two other embodiments of the present invention. It should be noted that the hybrid switching power conversion circuits in FIGS. 1A and 1B are also referred to as a Series Capacitor Buck Converter (SCBC). Furthermore, FIGS. 1A and 1B depict one embodiment of the hybrid switching power conversion circuit controlled by the control circuit of the present invention, and should not be construed as limiting the broadest scope of the invention. In other embodiments, the inductor circuit of the hybrid switching power conversion circuit include a pair of uncoupled inductors, such as the inductor circuit 211 of the hybrid switching power conversion circuit 2002C in FIG. 1C, or a single inductor, such as the inductor circuit 212 of the hybrid switching power conversion circuit 2002D in FIG. 1D.

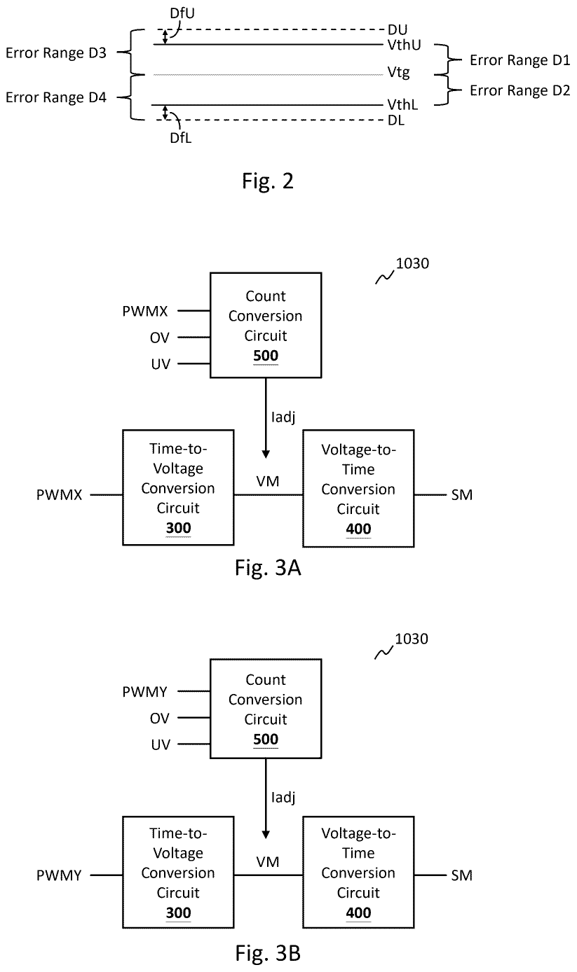

Please also refer to FIG. 2, which illustrates a schematic diagram of the regulation range of the flying capacitor voltage in one embodiment of the present invention. In one embodiment, the control circuit 1000 is configured to perform, based on the voltage VC1 across the flying capacitor C1, a first adjustment operation, in which the pulse width of the charging signal S1 is adjusted, and/or a second adjustment operation, in which the pulse width of the discharging signal S2 is adjusted. In other words, the control circuit 1000 of the present invention may perform the first adjustment operation, the second adjustment operation, or both, based on the voltage VC1 across the flying capacitor C1. Accordingly, the voltage VC1 across the flying capacitor C1 is regulated within an error range of a target voltage Vtg, where the error range is associated with a first predetermined threshold VthU and a second predetermined threshold VthL. In one embodiment, the first predetermined threshold VthU is greater than the second predetermined threshold VthL, the first predetermined threshold VthU is greater than the target voltage Vtg, and the second predetermined threshold VthL is less than the target voltage Vtg. In one embodiment, the target voltage Vtg is positively correlated with a divided voltage of the first power supply voltage V1. For example, in the embodiments of FIGS. 1A and 1B, the target voltage Vtg may be one-half of the first power supply voltage V1.

It should be noted that, in a steady state, the voltage VC1 across the flying capacitor C1 in the hybrid switching power conversion circuit is ideally equal to the target voltage Vtg. However, during the operation of the hybrid switching power conversion circuit, the unregulated voltage across the flying capacitor often deviates from the target voltage Vtg, resulting in a larger output current ripple and thus lower conversion efficiency. The present invention adjusts the pulse width of the charging signal and/or the pulse width of the discharging signals, such that the difference between the voltage VC1 across the flying capacitor C1 and the target voltage Vtg remains within an error range. In other words, the voltage VC1 across the flying capacitor C1 is regulated within an error range of the target voltage Vtg. In one embodiment, the error range is associated with the difference between the first predetermined threshold VthU and the target voltage Vtg, or the difference between the target voltage Vtg and the second predetermined threshold VthL, as shown by error ranges D1 or D2 respectively in FIG. 2. It should be noted that, due to the time required for regulation, in another embodiment, the error range may approximate but exceed the range between the target voltage Vtg and the first predetermined threshold VthU or the second predetermined threshold VthL, such as the error ranges D3 or D4 shown in FIG. 2, which respectively correspond to the difference between the upper error limit DU and the target voltage Vtg, or between the target voltage Vtg and the lower error limit DL. In one specific embodiment, when the target voltage Vtg is one-half of the first power supply voltage V1, the error ranges D1 or D2 may be 10% or less of the first power supply voltage V1. In addition, the difference DfU between the upper error limit DU and the first predetermined threshold VthU, and the difference DfL between the second predetermined threshold VthL and the lower error limit DL, may also be 10% or less of the first power supply voltage V1.

In one embodiment, the above-mentioned first adjustment operation includes: when the voltage VC1 across the flying capacitor C1 is higher than the first predetermined threshold VthU, decreasing the pulse width of the charging signal S1 to shorten the charging duration of the flying capacitor C1, thereby lowering the voltage VC1 across the flying capacitor C1; and when the voltage VC1 across the flying capacitor C1 is lower than the second predetermined threshold VthL, increasing the pulse width of the charging signal S1 to lengthen the charging duration of the flying capacitor C1, thereby raising the voltage VC1 across the flying capacitor C1. In one embodiment, the above-mentioned second adjustment operation includes: when the voltage VC1 across the flying capacitor C1 is higher than the first predetermined threshold VthU, increasing the pulse width of the discharging signal S2 to lengthen the discharging duration of the flying capacitor C1, thereby lowering the voltage VC1 across the flying capacitor C1; and when the voltage VC1 across the flying capacitor C1 is lower than the second predetermined threshold VthL, decreasing the pulse width of the discharging signal S2 to shorten the discharging duration of the flying capacitor C1, thereby raising the voltage VC1 across the flying capacitor C1. Details of the first and second adjustment operations will be further described in subsequent embodiments.

FIGS. 3A and 3B illustrate block diagrams of partial control circuits (pulse width correction circuit 1030) of the hybrid switching power conversion circuits in accordance with two embodiments of the present invention. In one embodiment, the pulse width correction circuit 1030 includes a time-to-voltage conversion circuit 300, a voltage-to-time conversion circuit 400, and a count conversion circuit 500. In one embodiment, as shown in FIG. 3A, the first adjustment operation includes that the time-to-voltage conversion circuit 300 is configured to convert the pulse width of the first input signal PWMX into a correction voltage VM, and that the voltage-to-time conversion circuit 400 is configured to convert the correction voltage VM into a correction signal SM. In one embodiment, in the first adjustment operation of FIG. 3A, the count conversion circuit 500 is configured to generate an adjustment current Iadj based on the first input signal PWMX, the over-voltage signal OV, and the under-voltage signal UV. The adjustment current Iadj is configured to adjust the correction voltage VM, thereby adjusting the correction signal SM based on the voltage VC1 across the flying capacitor C1. It should be noted that the over-voltage signal OV is configured to indicate that the voltage VC1 across the flying capacitor C1 is higher than the first predetermined threshold VthU, and the under-voltage signal UV is configured to indicate that the voltage VC1 is lower than the second predetermined threshold VthL. Details will be described later.

The embodiment in FIG. 3B illustrates the block diagram of the second adjustment operation, which differs from the embodiment in FIG. 3A in that the second adjustment operation generates the correction signal SM based on the second input signal PWMY. The details can be inferred from the description of FIG. 3A and are therefore not repeated here.

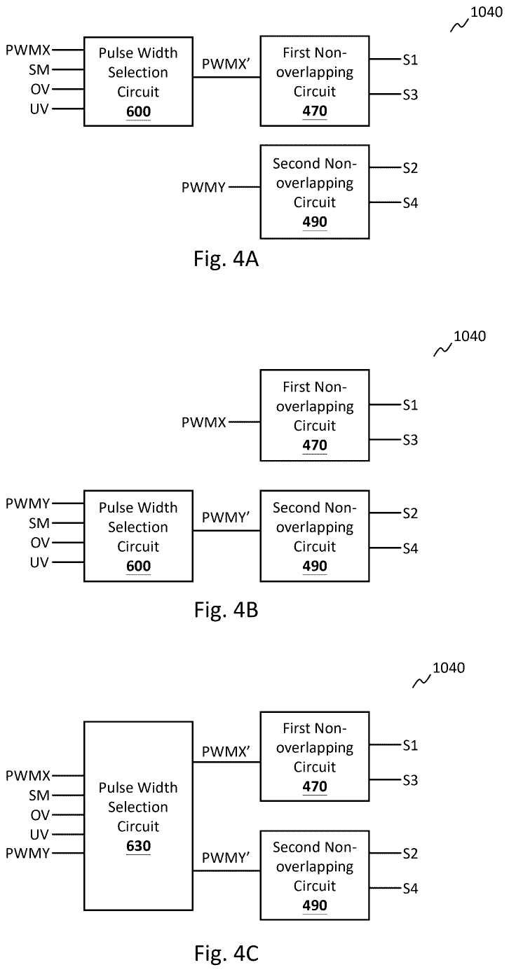

FIGS. 4A to 4C illustrate block diagrams of partial control circuits (switching signal generation circuits) of hybrid switching power conversion circuits in accordance with various embodiments of the present invention. The embodiments in FIGS. 4A and 4B respectively correspond to the control circuit 1000 operating in the first and second adjustment operations respectively, and the embodiment in FIG. 4C corresponds to the control circuit 1000 simultaneously performing both the first and second adjustment operations. In one embodiment, the switching signal generation circuit 1040 includes a pulse width selection circuit 600, a first non-overlapping circuit 470, and a second non-overlapping circuit 490.

In one embodiment, as shown in FIG. 4A, the pulse width selection circuit 600 is configured to generate a processed first input signal PWMX′ based on the first input signal PWMX, the correction signal SM, the over-voltage signal OV, and the under-voltage signal UV. The first non-overlapping circuit 470 is configured to generate the charging signal S1 and the first control signal S3 based on the processed first input signal PWMX′. The second non-overlapping circuit 490 is configured to generate the discharging signal S2 and the second control signal S4 based on the second input signal PWMY. In this embodiment, the first adjustment operation includes: generating the charging signal S1 based on the first input signal PWMX and the correction signal SM. In one specific embodiment, when the over-voltage signal OV is enabled, a pulse width of the charge signal S1 is determined by a shorter one between a pulse width of the first input signal PWMX and a pulse width of the correction signal SM; when the under-voltage signal UV is enabled, the pulse width of the charge signal S1 is determined by a longer one between the pulse width of the first input signal PWMX and the pulse width of the correction signal SM.

Specifically, in the embodiment of FIG. 4A, when the over-voltage signal OV is enabled, indicating that the voltage VC1 across the flying capacitor C1 is higher than the first predetermined threshold VthU, the pulse width of the correction signal SM is reduced so that the pulse width of the charging signal S1 is also reduced. When the under-voltage signal UV is enabled, indicating that the voltage VC1 across the flying capacitor C1 is lower than the second predetermined threshold VthL, the pulse width of the correction signal SM is increased so that the pulse width of the charging signal S1 is also increased.

In one embodiment, as shown in FIG. 4B, the pulse width selection circuit 600 is configured to generate a processed second input signal PWMY′ based on the second input signal PWMY, the correction signal SM, the over-voltage signal OV, and the under-voltage signal UV. The second non-overlapping circuit 490 is configured to generate the discharging signal S2 and the second control signal S4 based on the processed second input signal PWMY′. The first non-overlapping circuit 470 is configured to generate the charging signal S1 and the first control signal S3 based on the first input signal PWMX. In this embodiment, the second adjustment operation includes: generating the correction signal SM based on the pulse width of the second input signal PWMY. In one specific embodiment, when the over-voltage signal OV is enabled, a pulse width of the discharge signal S2 is determined by a longer one between a pulse width of the second input signal PWMY and a pulse width of the correction signal SM; when the under-voltage signal UV is enabled, the pulse width of the discharge signal S2 is determined by a shorter one between the pulse width of the second input signal PWMY and the pulse width of the correction signal SM.

Specifically, in the embodiment of FIG. 4B, when the over-voltage signal OV is enabled, indicating that the voltage VC1 across the flying capacitor C1 is higher than the first predetermined threshold VthU, the pulse width of the correction signal SM is increased, thereby increasing the pulse width of the discharging signal S2. When the under-voltage signal UV is enabled, indicating that the voltage VC1 across the flying capacitor C1 is lower than the second predetermined threshold VthL, the pulse width of the correction signal SM is decreased, thereby decreasing the pulse width of the discharging signal S2.

The embodiments shown in FIGS. 4A and 4B adjust the correction signal SM to respectively adjust the pulse widths of the charging signal S1 and the discharging signal S2, thereby regulating the voltage VC1 across the flying capacitor C1 within an error range around a target voltage Vtg. In the embodiment shown in FIG. 4C, the pulse width selection circuit 630 generates a processed first input signal PWMX′ and a processed second input signal PWMY′ based on the first input signal PWMX, the second input signal PWMY, the correction signal SM, the over-voltage signal OV, and the under-voltage signal UV. Specifically, since the first and second input signals PWMX and PWMY are non-overlapping signals, the embodiment in FIG. 4C time-multiplexes the adjustment of the pulse widths of the charging signal S1 and the discharging signal S2 by adjusting the correction signal SM, thereby regulating the voltage VC1 across the flying capacitor C1 within the error range of the target voltage Vtg. Other details in FIG. 4C can be inferred from the descriptions of FIGS. 4A and 4B. The following description will take FIGS. 3B and 4B as examples to illustrate the operation details of one specific embodiment (i.e., the second adjustment operation), and a person skilled in the art may infer the operational details of FIGS. 3A, 4A, and 4C accordingly.

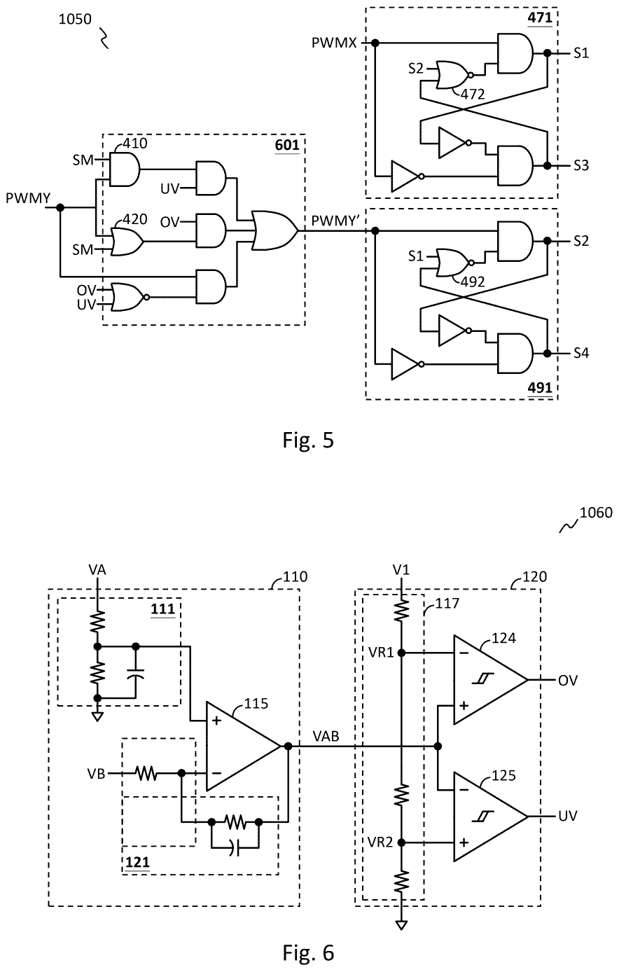

FIG. 5 shows a schematic diagram of a portion of a control circuit (switching signal generation circuit 1050) of a hybrid switched-mode power converter according to one specific embodiment of the present invention. FIG. 5 corresponds to one specific embodiment related to FIG. 4B. In one embodiment, as shown in FIG. 5, the first non-overlapping circuit 471 includes AND gates, a NOR gate, and inverters, and is configured to generate the charging signal S1 and the first control signal S3 based on the first input signal PWMX. In this embodiment, the first non-overlapping circuit 471 is also configured to ensure that the charging signal S1 is enabled to turn on the first transistor Q1 when both the second transistor Q2 and the third transistor Q3 (the discharge path controlled by the discharging signal S2 via the NOR gate 472) are in an off state. In one embodiment, the pulse width selection circuit 601 includes AND gates, an OR gate, and an NOR gate, and is configured to generate a processed second input signal PWMY′ based on the second input signal PWMY, the correction signal SM, the over-voltage signal OV, and the under-voltage signal UV. In one embodiment, the second non-overlapping circuit 491 includes AND gates, a NOR gate, and inverters, and is configured to generate the discharging signal S2 and the second control signal S4 based on the processed second input signal PWMY′. In this embodiment, the second non-overlapping circuit 491 is also configured to ensure that the discharging signal S2 is enabled to turn on the second transistor Q2 when both the first transistor Q1 and the fourth transistor Q4 (the charge path controlled by the charging signal S1 via the NOR gate 492) are in an off state.

In one embodiment, as shown in FIG. 5, when the over-voltage signal OV is enabled, the pulse width of the correction signal SM is adjusted to be wider than that of the second input signal PWMY. In this case, the OR gate 420 is configured to select the wider one between the second input signal PWMY and the correction signal SM (i.e., the correction signal SM) to determine the pulse width of the discharging signal S2. In one embodiment, when the under-voltage signal UV is enabled, the pulse width of the correction signal SM is adjusted to be narrower than that of the second input signal PWMY. In this case, the AND gate 410 is configured to select the narrower one between the second input signal PWMY and the correction signal SM (i.e., the correction signal SM) to determine the pulse width of the discharging signal S2. In one embodiment, when both the over-voltage signal OV and the under-voltage signal UV are disabled, the pulse width of the discharging signal S2 is directly determined based on the second input signal PWMY. It should be noted that, in one embodiment, during the second adjustment operation, when the first input signal PWMX is enabled, the discharging signal S2 is not enabled.

Under the teachings of FIG. 5, corresponding implementations of the pulse width selection circuit and non-overlapping circuits shown in FIGS. 4A and 4C can also be realized. The details are omitted herein for brevity.

FIG. 6 shows a schematic diagram of a portion of the control circuit (voltage detection circuit) of a hybrid switched-mode power converter according to one specific embodiment of the present invention. In one embodiment, the voltage detection circuit 1060 includes an amplification circuit 110 and a comparison circuit 120. In one specific embodiment, the amplification circuit 110 includes an error amplifier 115 and filter circuits 111 and 121, which are configured to generate a capacitor voltage signal VAB based on the first terminal voltage VA and the second terminal voltage VB of the flying capacitor. The capacitor voltage signal VAB is positively correlated with the voltage VC1 across the flying capacitor C1. In one specific embodiment, the comparison circuit 120 includes comparators 124 and 125, and a voltage divider 117, and is configured to compare the capacitor voltage signal VAB with a first threshold reference voltage VR1, or with a second threshold reference voltage VR2. When the capacitor voltage signal VAB is higher than the first threshold reference voltage VR1, an over-voltage signal OV is generated to indicate that the voltage VC1 across the flying capacitor C1 is higher than the first predetermined threshold VthU. When the capacitor voltage signal VAB is lower than the second threshold reference voltage VR2, an under-voltage signal UV is generated to indicate that the voltage VC1 across the flying capacitor C1 is lower than the second predetermined threshold VthL. In this embodiment, the first and second threshold reference voltages VR1 and VR2 are positively correlated with voltage divisions of the first power supply voltage V1, and are respectively correlated to the predetermined thresholds VthU and VthL.

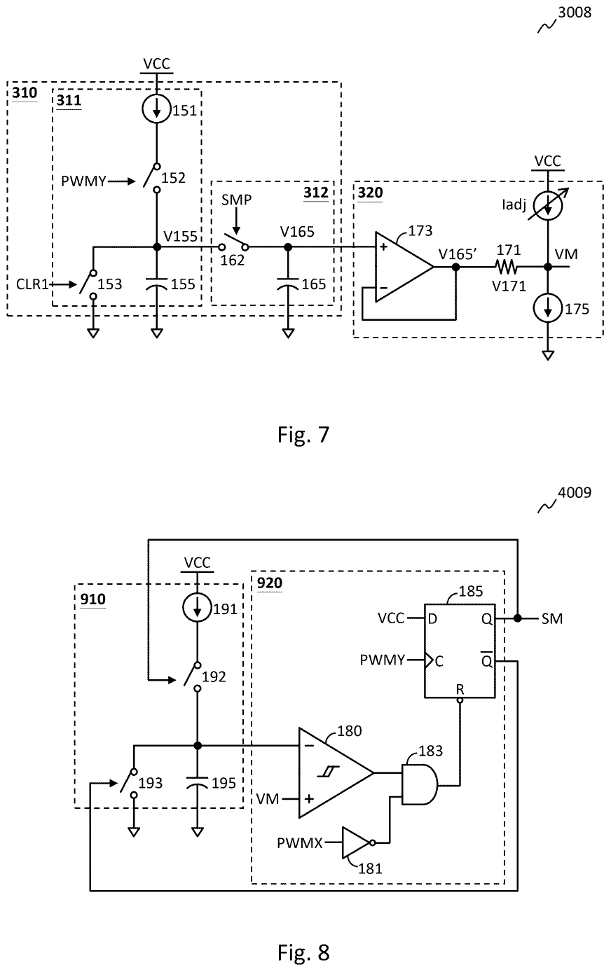

FIG. 7 shows a schematic diagram of a time-to-voltage conversion circuit of the control circuit according to one specific embodiment of the present invention. In one embodiment, the time-to-voltage conversion circuit 3008 includes a timing circuit 310 and a correction voltage generation circuit 320. In one embodiment, the timing circuit 310 includes an integration circuit 311 and a sample-and-hold circuit 312. In one specific embodiment, the second input signal PWMY controls the switch 152 such that a constant current source 151 charges a capacitor 155 via the switch 152, whereby the voltage V155 across the capacitor 155 after the integration ends (i.e., when PWMY is disabled) corresponds to (e.g., is proportional to) the pulse width of the second input signal PWMY. When the second input signal PWMY becomes disabled, the signal SMP is enabled to turn on the switch 162 so that the voltage V155 is sampled to a capacitor 165, thereby generating a time voltage V165. When the signal SMP is disabled to turn off the switch 162, a reset signal CLR1 is configured to turn on switch 153 to reset the voltage V155. In one specific embodiment, in the correction voltage generation circuit 320, the amplifier 173 buffers the time voltage V165 to generate a voltage V165′, and the correction voltage VM is generated based on the superposition (e.g., the sum) of the voltage V165′ (equals to the time voltage V165) and a bias voltage V171. In this embodiment, the bias voltage V171 is generated based on a bias resistor 171 and an adjustment current Iadj, and can be expressed by the following equation:

V171=(Iadj−I175)×R171

wherein the current I175 is the current value of the constant current source 175, and R171 is the resistance value of the bias resistor 171.

FIG. 8 shows a schematic diagram of the voltage-to-time conversion circuit of the control circuit according to one specific embodiment of the present invention. In one embodiment, the voltage-to-time conversion circuit 4009 includes an integration circuit 910 and a correction signal generation circuit 920. In one specific embodiment, a flip-flop 185 is triggered by the second input signal PWMY to enable the correction signal SM. Simultaneously, the correction signal SM controls the switch 192 to turn on, so that the constant current source 191 begins charging the capacitor 195. When the voltage of capacitor 195 reaches the correction voltage VM, the comparator 180 resets the flip-flop 185 to disable the correction signal SM, thereby achieving the voltage-to-time conversion. After the correction signal SM is disabled, the capacitor 195 is discharged and reset through switch 193. On the other hand, when the first input signal PWMX is enabled, the inverter 181 and the AND gate 183 immediately reset and disable the correction signal SM to prevent signal overlap. It should be noted that the pulse width of the discharging signal S2 is adjusted using the correction signal SM, which is determined based on the correction voltage VM. Therefore, to ensure consistency in device matching and signal behavior, the constant current source 151 in FIG. 7 and the constant current source 191 in FIG. 8 must be correlated, and the capacitor 155 in FIG. 7 and the capacitor 195 in FIG. 8 must also be correlated (e.g., matched in an IC circuit). The constant current sources 151 and 191 in FIGS. 7 and 8 are powered by the supply voltage VCC.

In the embodiments of FIGS. 7 and 8, the second adjustment operation includes: when the over-voltage signal OV is enabled, increasing the adjustment current Iadj to raise the correction voltage VM, thereby increasing the pulse width of the discharging signal S2; and when the under-voltage signal UV is enabled, decreasing the adjustment current Iadj to lower the correction voltage VM, thereby reducing the pulse width of the discharging signal S2.

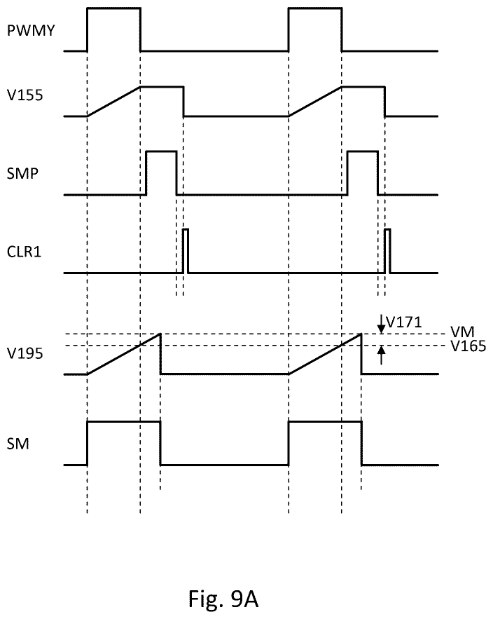

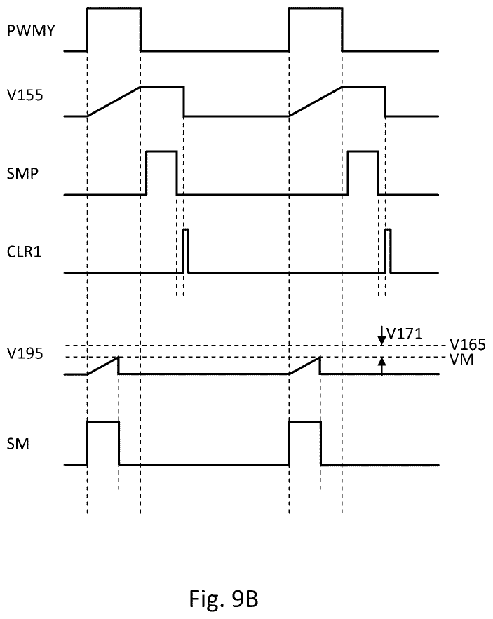

Please also refer to FIGS. 7, 8, 9A, and 9B. FIGS. 9A and 9B illustrate operational waveform diagrams corresponding to the operations of FIGS. 7 and 8, respectively. In one specific embodiment, as shown in FIG. 9A, when the over-voltage signal OV is enabled, the adjustment current Iadj is increased, causing the correction voltage VM to be higher than the time voltage V165, thereby lengthening the pulse width of the correction signal SM longer than that of the second input signal PWMY. In another specific embodiment, as shown in FIG. 9B, when the under-voltage signal UV is enabled, the adjustment current Iadj is decreased, causing the correction voltage VM to be lower than the time voltage V165, thereby shortening the pulse width of the correction signal SM shorter than that of the second input signal PWMY. In one embodiment, during the second adjustment operation, the enable time point of the correction signal SM is synchronized with the enable time point of the second input signal PWMY. It should be noted that FIGS. 9A and 9B illustrate the waveforms of the second adjustment operation. In one embodiment, during the first adjustment operation, the enable time point of the correction signal SM is synchronized with that of the first input signal PWMX. Other waveform details in FIGS. 9A and 9B can be inferred from the descriptions of FIGS. 7 and 8.

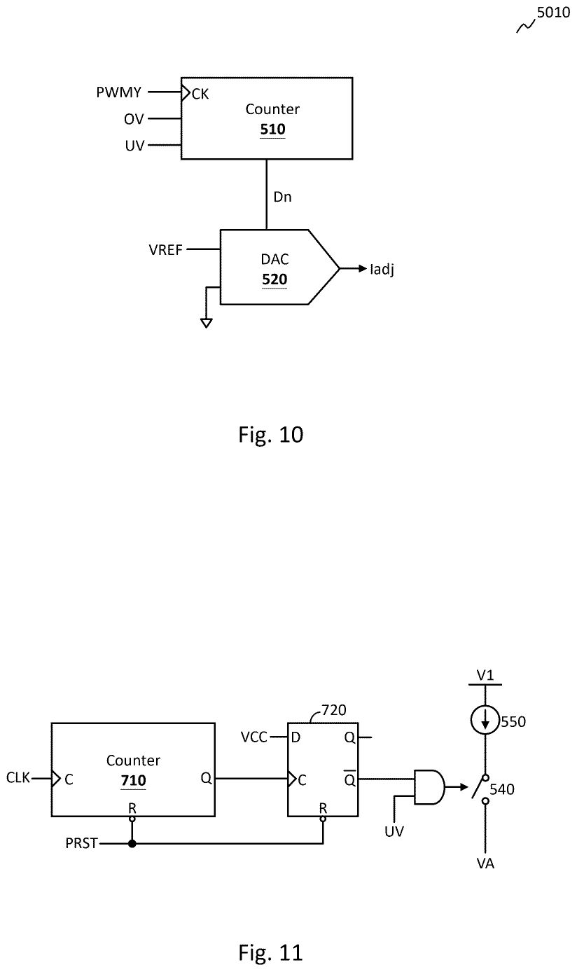

FIG. 10 shows a schematic diagram of the count conversion circuit of the control circuit according to one specific embodiment of the present invention. In one embodiment, the count conversion circuit 5010 includes a counter 510 and an adjustment current generator which is configured as a digital-to-analog converter (DAC) 520. In one embodiment, the second adjustment operation includes that the counter 510 is configured to generate a digital count value Dn based on the second input signal PWMY, the over-voltage signal OV, and the under-voltage signal UV, and that the digital-to-analog converter 520 is configured to generate an adjustment current Iadj based on the count value Dn and a reference signal VREF. In this embodiment, the counter 510 begins to count based on the enable time point of the second input signal PWMY, that is, the counter 510 uses the second input signal PWMY as a clock. In one specific embodiment, when the over-voltage signal OV is enabled, the counter 510 increments the count, thereby increasing the adjustment current Iadj; when the under-voltage signal UV is enabled, the counter 510 decrements the count, thereby decreasing the adjustment current Iadj.

It should be noted that in the embodiments of the second adjustment operation shown in FIGS. 5 to 8, FIGS. 9A and 9B, and FIG. 10, the adjustment current Iadj is adjusted in a cycle-by-cycle manner according to the over-voltage signal OV or under-voltage signal UV, so as to adjust the correction voltage VM and thereby adjusting the correction signal SM, which in turn adjusts the discharging signal S2 to gradually regulate the voltage across the flying capacitor C1. In the embodiments of the second adjustment operation described above, the cycle-by-cycle manner corresponds to each switching cycle of the second input signal PWMY. In other words, the adjustment of the discharging signal S2 based on the correction signal SM is synchronized with each switching cycle of the second input signal PWMY.

FIG. 11 shows a schematic diagram of a pre-charging circuit of the control circuit according to one specific embodiment of the present invention. In one embodiment, the control circuit of the present invention further includes a pre-charging circuit configured to pre-charge the flying capacitor during power-up of the hybrid switching power conversion circuit. In one embodiment, when the hybrid switching power conversion circuit starts up, a power-on reset signal PRST resets a counter 710 and a flip-flop 720. Subsequently, the counter 710 counts based on a clock signal CLK until overflow, defining the power-on duration. In one embodiment, when the counter 710 overflows, the flip-flop 720 is set to active. In one embodiment, if the under-voltage signal UV is enabled during the power-on period, a switch 540 turns on, allowing current from a constant current source 550 to flow to the first terminal voltage VA of the flying capacitor C1, thereby pre-charging the flying capacitor C1. The constant current source 550 is powered by the first supply voltage V1. During the pre-charging period described above, the charging signal S1, discharging signal S2, the first control signal S3, and the second control signal S4 are all disabled.

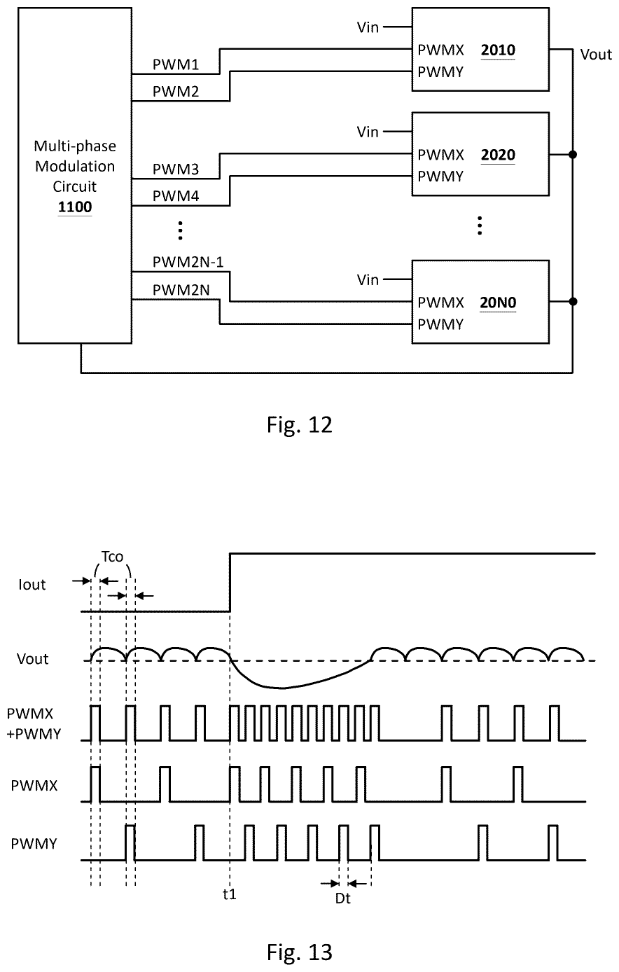

FIG. 12 illustrates a schematic diagram of the control circuit controlling a multi-phase power conversion circuit according to one embodiment of the present invention. As shown in FIG. 12, in one embodiment, the multi-phase power conversion circuit includes N (N-phase) hybrid switched-mode power converters 2010 to 20N0, configured to convert an input voltage Vin to generate an output voltage Vout. A multi-phase modulation circuit 1100 is configured to generate 2N pulse width modulation (PWM) signals PWM1 to PWM2N, for example based on feedback from the output voltage Vout. In one embodiment, for each of the hybrid switched-mode power converters 2010 to 20N0, the first input signal PWMX and the second input signal PWMY respectively receive the PWM signals PWM1, PWM2, PWM3, PWM4 to PWM2N-1, PWM2N. These converters operate based on the non-overlapping first and second input signals PWMX and PWMY, thereby maintaining the voltage balance VC1 across the flying capacitor C1. N is a positive integer herein.

FIG. 13 illustrates an operational waveform diagram of the multi-phase power conversion circuit corresponding to FIG. 12 according to one embodiment of the present invention. As shown in FIG. 13, in one embodiment, the first input signal PWMX and the second input signal PWMY have a constant conduction time Tco, and are non-overlapping. Thus, pulse width modulation is performed at a duty cycle period Dt of less than 50%, while maintaining the flying capacitor voltage VC1 (e.g., at half of the input voltage Vin). In one embodiment, the first and second input signals PWMX and PWMY are adjusted in response to load variations. For example, when the output current Iout increases (e.g., at time t1), the output voltage Vout decreases, triggering a reduction in the turn-off time of PWMX and PWMY. It should be noted that under maximum load conditions, PWMX and PWMY still remain non-overlapping and maintain a minimum off-time.

In one embodiment, the aforementioned PWM signals PWM1 to PWM2N may be fixed-frequency pulse width modulation signals.

It should be noted that, in one embodiment, the power conversion architecture controlled by the control circuit of the present invention may be a hybrid switched-mode power converter, which simultaneously features characteristics of both switched-capacitor and switched-inductor converters (as shown in the embodiments of FIG. 1A and FIG. 1B). The purpose of this architecture is to combine the hierarchical voltage conversion capability of capacitor-based converters with the continuous energy transfer characteristics of inductor-based converters, thereby achieving lower voltage differences across components, higher conversion efficiency, or finer output voltage level control.

Unlike simple modular cascading, the hybrid switching architecture in the present invention includes, for example, the following features: First, the control switches associated with the flying capacitor and the inductor are at least partially shared switching elements; Second, the switching operations related to the capacitor and inductor are coordinated via a common clock source or shared timing control unit, resulting in synchronized or consistent periodic operation. This structure not only improves the utilization efficiency of space and control resources, but also enables complementary interleaving behavior between the inductor and capacitor during energy conversion.

For example, in a typical three-level PWM hybrid architecture, the same set of upper and lower bridge switches can be configured to control the voltage levels at one terminal of the inductor, and also to switch the capacitive pumping or voltage-dividing paths of the flying capacitor. In different switching phases, it performs energy storage, transfer, and voltage regulation operations. In this context, the role of each switch is no longer exclusively tied to a specific component function, but rather forms an integrated energy transfer platform. This hybrid switching mechanism also allows one terminal of the capacitor to select from more than the original two voltage levels (Vhigh/Vlow), expanding to three or more levels, thereby offering greater control freedom and design flexibility.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A control circuit configured to control a hybrid switched-mode power converter, wherein the hybrid switched-mode power converter includes a plurality of transistors, a flying capacitor, and an inductor circuit, the inductor circuit including at least one inductor;
wherein the plurality of transistors are configured to be periodically switched under control of the control circuit, so as to switch electrical connections between the flying capacitor and a first power voltage, the inductor circuit, and a ground potential, and between the inductor circuit and the flying capacitor, the ground potential, and a second power voltage, thereby performing power conversion between the first power voltage and the second power voltage in a pulse width modulation (PWM) manner;
wherein the control circuit comprises:
a charge signal, configured to control a first transistor among the plurality of transistors to generate a charge current, such that the first power voltage charges the flying capacitor through the first transistor; and
a discharge signal, configured to control a second transistor among the plurality of transistors to generate a discharge current, such that the flying capacitor is discharged through the second transistor;
wherein the charge signal and the discharge signal are non-overlapping;
wherein the control circuit is configured to perform, according to a voltage across the flying capacitor, a first adjustment operation to adjust a pulse width of the charge signal, and/or a second adjustment operation to adjust a pulse width of the discharge signal, so as to regulate the voltage across the flying capacitor within an error range with respect to a target voltage, the error range being associated with a first predetermined threshold and a second predetermined threshold;
wherein the first predetermined threshold is greater than the target voltage, and the second predetermined threshold is less than the target voltage, wherein the target voltage is positively correlated with a divided voltage of the first power voltage.

2. The control circuit of claim 1, wherein the first adjustment operation includes:
decreasing the pulse width of the charge signal when the voltage across the flying capacitor is higher than the first predetermined threshold; and
increasing the pulse width of the charge signal when the voltage across the flying capacitor is lower than the second predetermined threshold;
wherein the second adjustment operation includes:
increasing the pulse width of the discharge signal when the voltage across the flying capacitor is higher than the first predetermined threshold;
decreasing the pulse width of the discharge signal when the voltage across the flying capacitor is lower than the second predetermined threshold.

3. The control circuit of claim 2, further comprising:
a first input signal;
a second input signal; and
a correction signal;
wherein the first adjustment operation further includes:
generating the correction signal based on a pulse width of the first input signal;
generating the charge signal based on the first input signal and the correction signal;
wherein when the voltage across the flying capacitor is higher than the first predetermined threshold, a pulse width of the correction signal is decreased so that the pulse width of the charge signal is decreased, and when the voltage across the flying capacitor is lower than the second predetermined threshold, the pulse width of the correction signal is increased so that the pulse width of the charge signal is increased;
wherein the second adjustment operation further includes:
generating the correction signal based on a pulse width of the second input signal; and
generating the discharge signal based on the second input signal and the correction signal;
wherein when the voltage across the flying capacitor is higher than the first predetermined threshold, the pulse width of the correction signal is increased so that the pulse width of the discharge signal is increased, and when the voltage across the flying capacitor is lower than the second predetermined threshold, the pulse width of the correction signal is decreased so that the pulse width of the discharge signal is decreased.

4. The control circuit of claim 3, wherein the plurality of transistors of the hybrid switched-mode power converter further include a third transistor and a fourth transistor, configured to be periodically switched based on a first control signal and a second control signal, respectively;
wherein the control circuit further includes a first non-overlapping circuit, configured to generate the charge signal and the first control signal based on the first input signal, or based on the first input signal and the correction signal;
wherein when the third transistor and the second transistor are not turned on, the first transistor is turned on.

5. The control circuit of claim 3, wherein the plurality of transistors of the hybrid switched-mode power converter further include a third transistor and a fourth transistor, configured to be periodically switched based on a first control signal and a second control signal, respectively;
wherein the control circuit further includes a second non-overlapping circuit, configured to generate the discharge signal and the second control signal based on the second input signal, or based on the second input signal and the correction signal;
wherein when the fourth transistor and the first transistor are not turned on, the second transistor is turned on.

6. The control circuit of claim 3, further comprising:
an amplification circuit, configured to generate a capacitor voltage signal according to a first terminal voltage and a second terminal voltage of the flying capacitor;
a comparison circuit, configured to compare the capacitor voltage signal with a first threshold reference voltage, or to compare the capacitor voltage signal with a second threshold reference voltage, so as to generate an over-voltage signal when the capacitor voltage signal is higher than the first threshold reference voltage, indicating that the voltage across the flying capacitor is higher than the first predetermined threshold; and to generate an under-voltage signal when the capacitor voltage signal is lower than the second threshold reference voltage, indicating that the voltage across the flying capacitor is lower than the second predetermined threshold;
wherein the first threshold reference voltage and the second threshold reference voltage are positively correlated with the first predetermined threshold and the second predetermined threshold, respectively.

7. The control circuit of claim 6, further comprising a timing circuit;
wherein the first adjustment operation further includes: the timing circuit being configured to generate a time voltage based on the pulse width of the first input signal;
wherein the second adjustment operation further includes: the timing circuit being configured to generate the time voltage based on the pulse width of the second input signal.

8. The control circuit of claim 7, further comprising:
a correction voltage, generated based on a sum of the time voltage and a bias voltage;
wherein the bias voltage is generated based on a bias resistor and an adjustment current;
wherein the second adjustment operation further includes: adjusting the adjustment current to adjust the correction voltage when the over-voltage signal is enabled, so as to decrease the pulse width of the charge signal, and adjusting the adjustment current to adjust the correction voltage when the under-voltage signal is enabled, so as to increase the pulse width of the charge signal;
wherein the second adjustment operation further includes: adjusting the adjustment current to adjust the correction voltage when the over-voltage signal is enabled, so as to increase the pulse width of the discharge signal, and adjusting the adjustment current to adjust the correction voltage when the under-voltage signal is enabled, so as to decrease the pulse width of the discharge signal.

9. The control circuit of claim 8,
wherein the first adjustment operation further includes:
adjusting the pulse width of the correction signal according to the correction voltage; and
adjusting the charge signal according to the correction signal;
wherein the second adjustment operation further includes:
adjusting the pulse width of the correction signal according to the correction voltage; and
adjusting the discharge signal according to the correction signal.

10. The control circuit of claim 3,
wherein the first adjustment operation further includes: adjusting the charge signal in a cycle-by-cycle manner to gradually regulate the voltage across the flying capacitor;
wherein the second adjustment operation further includes: adjusting the discharge signal in the cycle-by-cycle manner to gradually regulate the voltage across the flying capacitor;
wherein the cycle-by-cycle manner corresponds to each switching cycle of the first input signal or each switching cycle of the second input signal.

11. The control circuit of claim 3,
wherein, in the first adjustment operation, an enable time point of the correction signal is synchronized with an enable time point of the first input signal;
wherein, in the second adjustment operation, the enable time point of the correction signal is synchronized with an enable time point of the second input signal.

12. The control circuit of claim 8, further comprising a counter and an adjustment current generator;
wherein the first adjustment operation further includes:
the counter being configured to count to generate a first count value based on the first input signal, the over-voltage signal, and the under-voltage signal; and
the adjustment current generator being configured to generate the adjustment current according to the first count value;
wherein the counter is configured to start operating based on an enable time point of the first input signal;
wherein when the over-voltage signal is enabled, the counter decrements the first count value so that the adjustment current is reduced to lower the correction voltage, and when the under-voltage signal is enabled, the counter increments the first count value so that the adjustment current is increased to raise the correction voltage;
wherein the second adjustment operation further includes:
the counter being configured to generate a second count value based on the second input signal, the over-voltage signal, and the under-voltage signal; and
the adjustment current generator being configured to generate the adjustment current according to the second count value;
wherein the counter is configured to start operating based on an enable time point of the second input signal;
wherein when the over-voltage signal is enabled, the counter increments the second count value so that the adjustment current is increased to raise the correction voltage, and when the under-voltage signal is enabled, the counter decrements the second count value so that the adjustment current is reduced to lower the correction voltage.

13. The control circuit of claim 6,
wherein the first adjustment operation further includes: the pulse width of the charge signal being determined by a shorter one between the pulse width of the first input signal and the pulse width of the correction signal when the over-voltage signal is enabled;
wherein the second adjustment operation further includes: the pulse width of the discharge signal being determined by a longer one between the pulse width of the second input signal and the pulse width of the correction signal when the over-voltage signal is enabled.

14. The control circuit of claim 6,
wherein the first adjustment operation further includes: the pulse width of the charge signal being determined by a longer one between the pulse width of the first input signal and the pulse width of the correction signal when the under-voltage signal is enabled;
wherein the second adjustment operation further includes: the pulse width of the discharge signal being determined by a shorter one between the pulse width of the second input signal and the pulse width of the correction signal when the under-voltage signal is enabled.

15. The control circuit of claim 3,
wherein, in the first adjustment operation, when the second input signal is enabled, the charge signal is disabled;
wherein, in the second adjustment operation, when the first input signal is enabled, the discharge signal is disabled.

16. The control circuit of claim 3, further comprising a pre-charging circuit configured to pre-charge the flying capacitor during a power-on period of the hybrid switched-mode power converter.

17. The control circuit of claim 3,
wherein the first input signal and the second input signal are non-overlapping signals;
wherein the first input signal and the second input signal have a constant on-time.

18. The control circuit of claim 3, further configured to control a multi-phase power conversion circuit, wherein the multi-phase power conversion circuit includes a plurality of the hybrid switched-mode power converters and a multi-phase modulation circuit, wherein the multi-phase modulation circuit is configured to generate a corresponding plurality of pulse width modulation signals, respectively corresponding to the first input signal and the second input signal of each of the plurality of the hybrid switched-mode power converters.
